(19) United States
(12) Patent Application Publication
(10) Pub. No.: US 2016/0274584 A1
(43) Pub. Date: Sep. 22, 2016

(54) APPARATUS AND METHOD FOR AN INSPECTION DEVICE

(71) Applicant: Astec, Inc., Chattanooga, TN (US)

(72) Inventors: Charles Simpson, Soddy Daisy, TN (US); John Watson, Red Bank, TN (US); Albert Covington, Cleveland, TN (US); Kris Robertson, Chickamauga, GA (US)

(73) Assignee: Astec, Inc., Chattanooga, TN (US)

(21) Appl. No.: 15/074,283

(22) Filed: Mar. 18, 2016

Related U.S. Application Data
(60) Provisional application No. 62/134,860, filed on Mar. 18, 2015.

(51) Int. Cl. G05D 1/02; G01B 11/02; G05D 1/00

(52) U.S. Cl. CPC G05D 1/021; G05D 1/0011; G01B 11/02

(57) ABSTRACT

An inspection device comprising a body that is adapted to receive and retain an item of inspection equipment, one or more wheels that are rotatably mounted to the body, one or more power sources that are adapted to rotate the one or more wheels, and a controller that is adapted to control the movement of the inspection device. A method further comprising controlling the movement of the inspection device relative to the storage device.

### CROSS-REFERENCES TO RELATED APPLICATIONS/PATENTS

This application relates back to and claims the benefit of priority from U.S. Provisional Application for Patent Ser. No. 62/134,860 titled “Mobile Robot” and filed on Mar. 18, 2015.

### FIELD OF THE INVENTION

The present invention relates generally to inspection devices and methods, and particularly to a mobile, wirelessly-controlled inspection device and method for inspecting storage devices such as silos.

### BACKGROUND AND DESCRIPTION OF THE PRIOR ART

It is known to use various devices and methods to inspect silos. Conventional devices and methods, however, suffer from one or more disadvantages. For example, conventional devices and methods require an inspector to be at the site of the inspection. Conventional devices and methods also require scaffolding or other similar equipment. Conventional devices and methods are undesirably expensive, labor-intensive, and time-consuming. In addition, conventional devices and methods expose the inspector to undesirable safety risks. Conventional devices and methods further require excessive training and produce less than optimal inspection results.

It would be desirable, therefore, if an apparatus and method for an inspection device could be provided that would not require an inspector to be at the site of the inspection. It would also be desirable if such an apparatus and method for an inspection device could be provided that would not require scaffolding or other similar equipment. It would be further desirable if such an apparatus and method for an inspection device could be provided that would be less expensive, labor-intensive, and time-consuming. It would be still further desirable if such an apparatus and method for an inspection device could be provided that would minimize or eliminate safety risks to the inspector. It would also be desirable if such an apparatus and method for an inspection device could be provided that would reduce the required amount of training and produce improved inspection results.

### ADVANTAGES OF THE PREFERRED EMBODIMENTS OF THE INVENTION

Accordingly, it is an advantage of the preferred embodiments of the invention claimed herein to provide an apparatus and method for an inspection device that does not require an inspector to be at the site of the inspection. It is also an advantage of the preferred embodiments of the invention claimed herein to provide an apparatus and method for an inspection device that does not require scaffolding or other similar equipment. It is another advantage of the preferred embodiments of the invention claimed herein to provide an apparatus and method for an inspection device that is less expensive, labor-intensive, and time-consuming. It is an advantage of the preferred embodiments of the invention claimed herein to provide an apparatus and method for an inspection device that reduces or eliminates safety risks to the inspector. It is also an advantage of the preferred embodiments of the invention claimed herein to provide an apparatus and method for an inspection device that reduces the required amount of training and produces improved inspection results.

Additional advantages of the preferred embodiments of the invention will become apparent from an examination of the drawings and the ensuing description.

### SUMMARY OF THE INVENTION

The apparatus of the invention comprises an inspection device. The preferred inspection device comprises a body that is adapted to receive and retain an item of inspection equipment, one or more wheels that are rotatably mounted to the body, one or more power sources that are adapted to rotate the one or more wheels, and a controller that is adapted to control the movement of the inspection device.

The method of the invention comprises a method for inspecting a storage device. The preferred method comprises providing an inspection device. The preferred inspection device comprises a body that is adapted to receive and retain an item of inspection equipment, one or more wheels that are rotatably mounted to the body, one or more power sources that are adapted to rotate the one or more wheels, and a controller that is adapted to control the movement of the inspection device. The preferred method also comprises controlling the movement of the inspection device relative to the storage device.

### BRIEF DESCRIPTION OF THE DRAWINGS

The presently preferred embodiments of the invention are illustrated in the accompanying drawings, in which like reference numerals represent like parts throughout, and in which:

FIG. 1 is a front perspective view of the preferred embodiment of the inspection device in accordance with the present invention.

FIG. 2 is a front view of the preferred inspection device illustrated in FIG. 1.

FIG. 3 is a right side view of the preferred inspection device illustrated in FIGS. 1-2.

FIG. 4 is a top view of the preferred inspection device illustrated in FIGS. 1-3.

FIG. 5 is a partial sectional top view of a first alternative embodiment of the inspection device in accordance with the present invention.

FIG. 6 is a front view of the preferred embodiment of the wireless controller in accordance with the present invention.

FIG. 7 is a top view of the preferred wireless controller illustrated in FIG. 6.

FIG. 8 is a flow chart illustrating the preferred embodiment of the method for inspecting a storage device in accordance with the present invention.

### DESCRIPTION OF THE PREFERRED EMBODIMENTS OF THE INVENTION

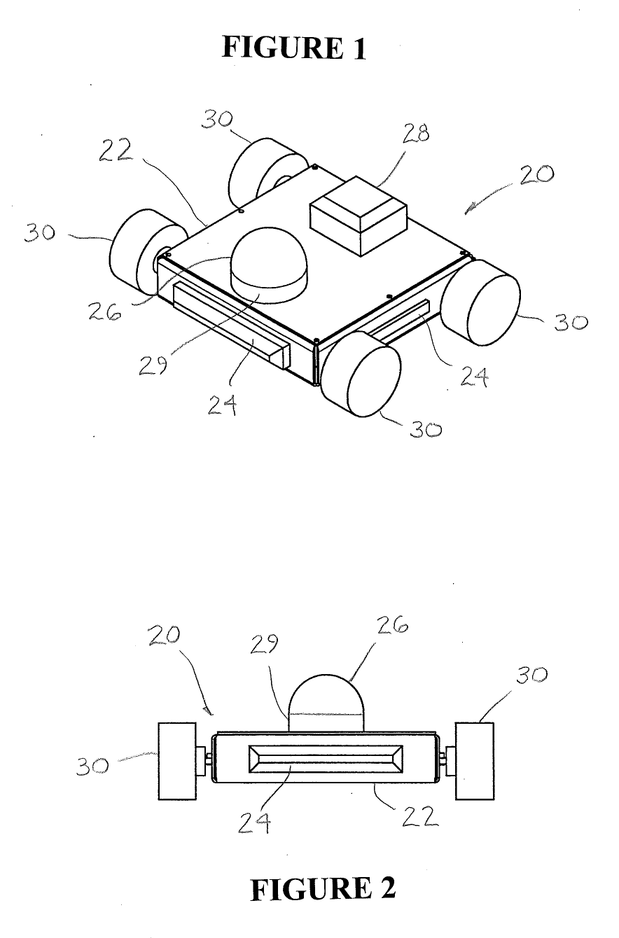

Referring now to the drawings, the preferred embodiments of the apparatus and method for an inspection device in accordance with the present invention are illustrated by FIGS. 1 through 8. As shown in FIGS. 1-8, the preferred embodiments of the invention described and claimed herein are adapted to provide an apparatus and method for an inspection device that does not require an inspector to be at the site of the inspection. The preferred embodiments of the invention described and claimed herein are also adapted to provide an apparatus and method for an inspection device that does not require scaffolding or other similar equipment. The preferred embodiments of the invention described and claimed herein are further adapted to provide an apparatus and method for an inspection device that is less expensive, labor-intensive, and time-consuming. The preferred embodiments of the invention described and claimed herein are still further adapted to provide an apparatus and method for an inspection device that reduces or eliminates safety risks to the inspector. In addition, the preferred embodiments of the invention described and claimed herein are adapted to provide an apparatus and method for an inspection device that reduces the required amount of training and produces improved inspection results.

Referring now to FIG. 1, a front perspective view of the preferred embodiment of the inspection device in accordance with the present invention is illustrated. As shown in FIG. 1, the preferred inspection device is designated generally by reference numeral 20. Preferred inspection device 20 comprises body 22, which is adapted to receive and retain lights 24 and an item of inspection equipment such as video camera 26, a sensor such as metal thickness measuring instrument 28, and/or Infrared vision system 29. Preferred video camera is a high definition (HD) camera that is adapted to be controlled by first person view (FPV) head gear. Preferred inspection device 20 also comprises wheels 30 which are rotatably mounted to body 22. Preferably, wheels 30 are magnetic so they can adhere to the metal surface of a storage device such as a silo. It is also contemplated within the scope of the invention that the wheels may be rubber or any other suitable material adapted for ground-based inspections. While FIG. 1 illustrates the preferred configuration and arrangement of the inspection device in accordance with the present invention, it is contemplated within the scope of the invention that the inspection device may be of any suitable configuration and arrangement. It is also contemplated within the scope of the invention that the inspection device may be adapted to receive and retain any other suitable items such as extra batteries and the like.

Referring now to FIG. 2, a front view of preferred inspection device 20 is illustrated. As shown in FIG. 2, preferred inspection device 20 comprises body 22, light 24, video camera 26, Infrared vision system 29, and wheels 30.

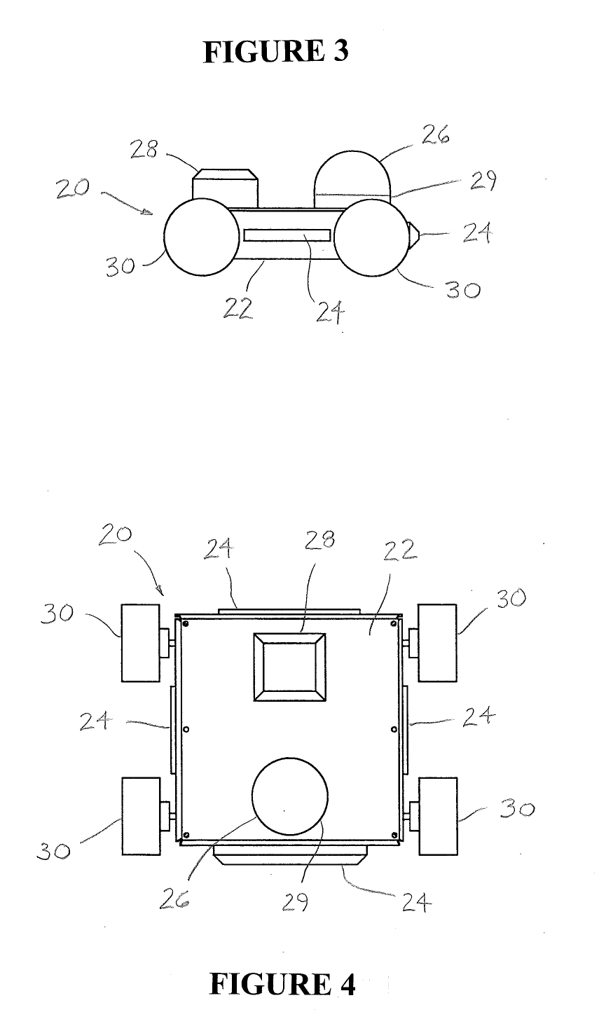

Referring now to FIG. 3, a right side view of preferred inspection device 20 is illustrated. As shown in FIG. 3, preferred inspection device 20 comprises body 22, light 24, video camera 26, metal thickness measuring instrument 28, Infrared vision system 29, and wheels 30.

Referring now to FIG. 4, a top view of preferred inspection device 20 is illustrated. As shown in FIG. 4, preferred inspection device 20 comprises body 22, lights 24, video camera 26, metal thickness measuring instrument 28, Infrared vision system 29, and wheels 30.

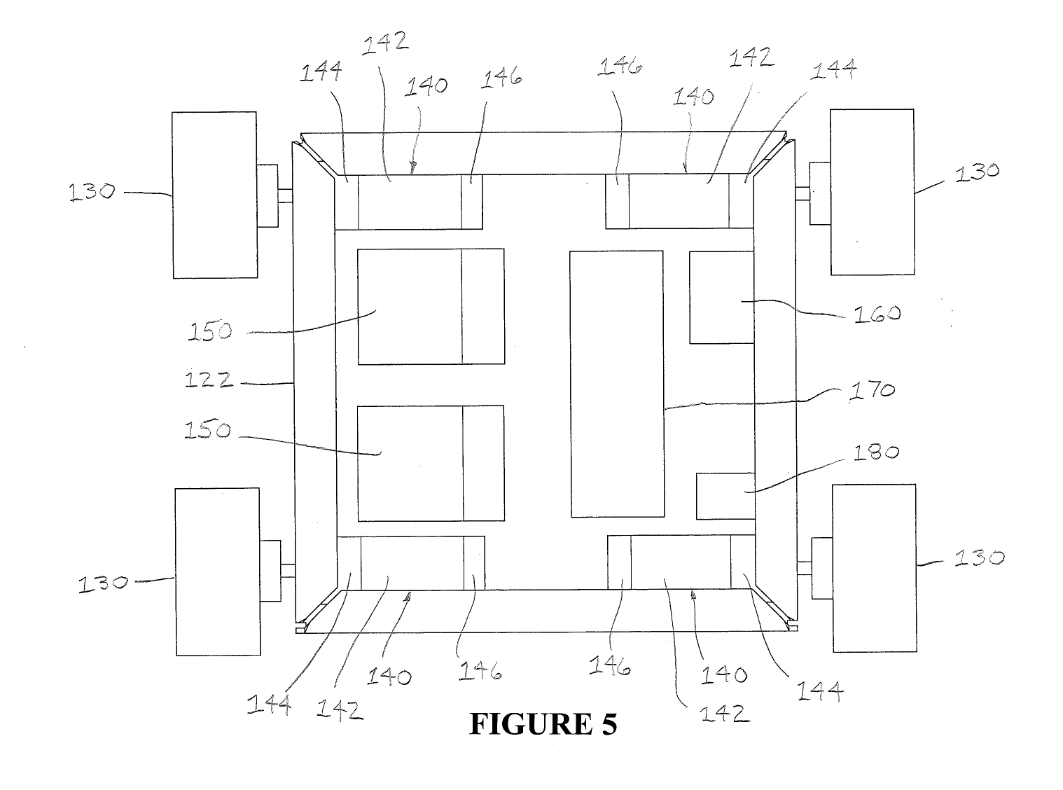

Referring now to FIG. 5, a partial sectional top view of a first alternative embodiment of the inspection device in accordance with the present invention is illustrated. As shown in FIG. 5, the preferred inspection device is designated generally by reference numeral 120. Preferred inspection device 120 comprises body 122 which is adapted to receive and retain an item of inspection equipment such as a video camera, a metal thickness measuring instrument, and/or an Infrared vision system (see FIGS. 1-4). Preferred inspection device 120 also comprises wheels 130 which are rotatably mounted to body 122. Preferably, wheels 130 are magnetic so they can adhere to the metal surface of a storage device such as a silo. It is also contemplated within the scope of the invention that the wheels may be rubber or any other suitable material adapted for ground-based inspections. Preferred inspection device 120 further comprises power sources 140 which are adapted to rotate wheels 130. Preferably, power sources 140 comprise DC gear motors 142 which are adapted to be independently controlled. Preferred power sources 140 also comprise gear boxes 144 which are adapted to reduce the final drive output to facilitate increased output torque and control precision and encoders 146 which enable the motion controller to identify the exact position of the motors in relation to the longitudinal axis of the motor shaft and allows for the exact positioning of the wheels and determination of their rotational speed.

Still referring to FIG. 5, preferred inspection device 120 also comprises a pair of controllers 150 adapted to control the movement of the inspection device. Preferably, each of controllers 150 comprises a power source controller such as a solid state motor or speed controller having a metal-oxide-semiconductor field-effect transistor (MOSFET) H-Bridge circuit adapted to control the speed of each motor. In addition, each of controllers 150 also preferably comprises a motion controller such as a mixed mode motion controller and/or a speed and torque controlled motion controller. More particularly, a proportional-integral-derivative (PID) controller having microprocessor based PID circuits may be used as a fly-by-wire (FBW) system to smooth the operation of the motors. Preferably, the PID controller is adapted to add power to the motor when a load is sensed in order to maintain the constant motor RPM. The preferred PID controller is also adapted to smooth the operation of the drive system by intercepting the user's inputs and smoothing them. Preferred inspection device also comprises wireless control receiver 160 which is adapted to receive radio signals for controlling the movement of the device and transmit telemetry uplink which is a data stream including live system data such as battery voltage, current draw, altitude, temperature, ground speed, sensor data, and the like from the inspection device to a ground station. Preferred inspection device further comprises battery 170 which is adapted to provide an energy source to the device. Preferred inspection device 20 still further comprises an autonomous controller such as autopilot 180 which is controlled via packetized serial commands and allows for unmanned operation of the device. Preferred inspection device 120 is adapted to be radio controlled. While FIG. 5 illustrates the preferred configuration and arrangement of the inspection device in accordance with the present invention, it is contemplated within the scope of the invention that the inspection device may be of any suitable configuration and arrangement.

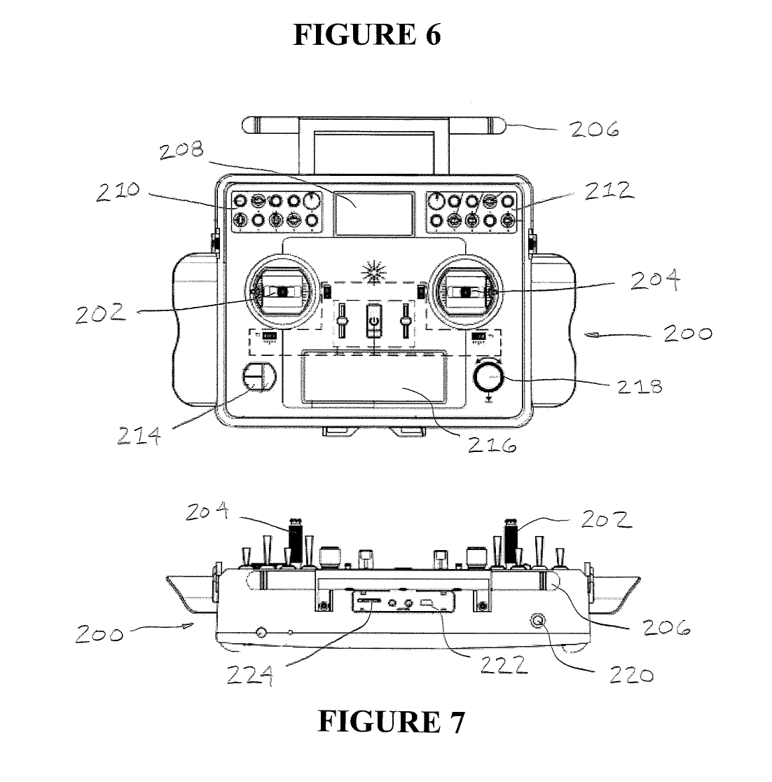

Referring now to FIG. 6, a front view of preferred wireless controller 200 is illustrated. As shown in FIG. 6, the preferred wireless controller is a human-controlled wireless controller and designated generally by reference numeral 200. Preferred wireless controller 200 comprises a camera control device such as camera control joystick 202, a motion control device such as motion control joystick 204, antenna 206, telemetry screen 208, a first switch panel 210, a second switch panel 212, navigation buttons 214, control screen 216, and input control knob 218.

Referring now to FIG. 7, a top view of the preferred embodiment of the wireless controller in accordance with the present invention is illustrated. As shown in FIG. 7, preferred wireless controller 200 comprises a camera control device such as camera control joystick 202, a motion control device such as motion control joystick 204, antenna 206, recharge ports 220 and 222, and micro SD storage 224. While FIGS. 6 and 7 illustrate the preferred configuration and arrangement of the wireless controller in accordance with the present invention, it is contemplated within the scope of the invention that the wireless controller may be of any suitable configuration and arrangement. It is also contemplated within the scope of the invention that the controller may be a wired device, mechanism, assembly, or combination thereof.

The invention also comprises a method for inspecting a storage device. The preferred method comprises providing an inspection device. The preferred inspection device comprises a body that is adapted to receive and retain an item of inspection equipment, one or more wheels that are rotatably mounted to the body, one or more power sources that are adapted to rotate the one or more wheels, and a controller that is adapted to control the movement of the inspection device. The preferred method also comprises controlling the movement of the inspection device relative to the storage device.

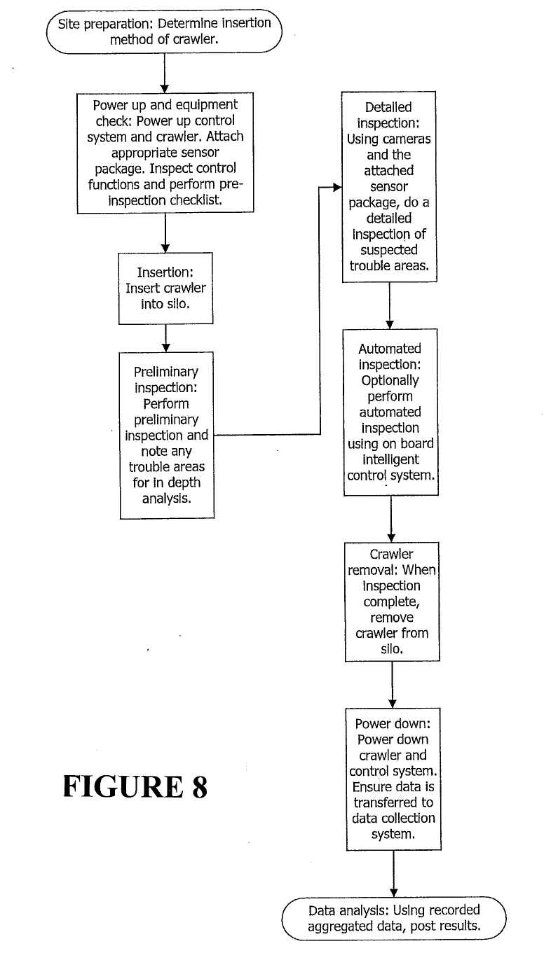

Referring now to FIG. 8, a flow chart outlining the preferred method for inspecting a storage device in accordance with the present invention is illustrated. More particularly, in the preferred methods for inspecting a storage device, the inspection site is initially prepare and the preferred method and location for inserting the inspection device into the storage device is determined. After the inspection site is prepared, the inspection device and the control system are powered up and the appropriate items of inspection equipment are attached to the device. The control functions are inspected and the pre-inspection checklist is reviewed. When the inspection device is ready for operation, it is inserted into the storage device to perform a preliminary inspection in order to identify any trouble areas for a more detailed inspection. The inspection device then performs a detailed inspection of the identified trouble areas using cameras and any other attached item of inspection equipment. The control signals received by the inspection device may originate from a human-controlled wireless 2.4 GHz controller. In the alternative, the inspection device may perform an automated inspection using control signals originating from the on-board autonomous controller or autopilot and sent via packetized serial commands. In either case, the signals are parsed through the on-board motion controllers. When the inspection is complete, the inspection device is removed from the storage device and the data collected by the inspection device is transferred to a data collection system where it can be recorded, aggregated, analyzed, posted, and the like. Preferably, the data collected by the inspection device is wireless transferred to either a ground-based telemetry computer and/or a human wearable video unit containing a heads up display with the information. In addition, the data is preferably recorded for future analysis via a wireless data link and computer interface package. Thereafter, the inspection device and the control system are powered down. While FIG. 8 illustrates the preferred method for inspecting a storage device, it is contemplated within the scope of the invention that the steps of the method may be performed in any suitable sequence.

In operation, several advantages of the preferred embodiments of the inspection device are achieved. For example, the preferred embodiments of the invention described and claimed herein are adapted to provide an apparatus and method for an inspection device that does not require an inspector to be at the site of the inspection. The preferred embodiments of the invention described and claimed herein are also adapted to provide an apparatus and method for an inspection device that does not require scaffolding or other similar equipment. The preferred embodiments of the invention described and claimed herein are further adapted to provide an apparatus and method for an inspection device that is less expensive, labor-intensive, and time-consuming. The preferred embodiments of the invention described and claimed herein are still further adapted to provide an apparatus and method for an inspection device that reduces or eliminates safety risks to the inspector. In addition, the preferred embodiments of the invention described and claimed herein are adapted to provide an apparatus and method for an inspection device that reduces the required amount of training and produces improved inspection results. Although this description contains many specifics, these should not be construed as limiting the scope of the invention but as merely providing illustrations of some of the presently preferred embodiments thereof, as well as the best mode contemplated by the inventors of carrying out the invention. The invention, as described herein, is susceptible to various modifications and adaptations, and the same are intended to be comprehended within the meaning and range of equivalents of the appended claims.

What is claimed is:

1. An inspection device, said inspection device comprising:
(a) a body, said body be adapted to receive and retain an item of inspection equipment;
(b) one or more wheels, said one or more wheels being rotatably mounted to the body;
(c) one or more power sources, said one or more power sources being adapted to rotate the one or more wheels;
(d) a controller, said controller being adapted to control the movement of the inspection device.

2. The inspection device of claim 1 wherein the item of inspection equipment comprises a video camera.

3. The inspection device of claim 1 wherein the item of inspection equipment comprises a metal thickness measuring instrument.

4. The inspection device of claim 1 wherein the item of inspection equipment comprises an Infrared vision system.

5. The inspection device of claim 1 wherein the one or more wheels are magnetic.

6. The inspection device of claim 1 wherein the one or more power sources comprise a DC gear motor.

7. An inspection device, said inspection device comprising:
(a) a body, said body be adapted to receive and retain an item of inspection equipment;
(b) one or more wheels, said one or more wheels being rotatably mounted to the body;
(c) one or more power sources, said one or more power sources being adapted to rotate the one or more wheels;
(d) one or more power source controllers, said one or more power source controllers being adapted to control the one or more power sources;
(e) one or more motion controllers, said one or more motion controllers being adapted to control the movement of the movement of the inspection device.

8. The inspection device of claim 7 wherein the item of inspection equipment comprises a video camera.

9. The inspection device of claim 7 wherein the item of inspection equipment comprises metal thickness measuring instrument.

10. The inspection device of claim 7 wherein the item of equipment comprises an Infrared vision system.

11. The inspection device of claim 7 wherein the one or more wheels are magnetic.

12. The inspection device of claim 7 wherein the one or more power sources comprise an independently controlled DC gear motor.

13. The inspection device of claim 7 wherein the one or more power source controllers comprise a solid state motor controller.

14. The inspection device of claim 7 wherein the one or more motion controllers comprise a mixed mode motion controller.

15. The inspection device of claim 7 wherein the one or more motion controllers comprise a speed and torque controlled motion controller.

16. The inspection device of claim 7 further comprising an autopilot controlled via packetized serial commands.

17. The inspection device of claim 7 further comprising a human-controlled, wireless controller.

18. The inspection device of claim 17 wherein the human-controlled, wireless controller comprises a joystick.

19. The inspection device of claim 7 wherein the inspection device is radio controlled.

20. A method for inspecting a storage device, said method comprising:
(a) providing an inspection device, said inspection device comprising:
(i) a body, said body be adapted to receive and retain an item of inspection equipment;
(ii) one or more wheels, said one or more wheels being rotatably mounted to the body;
(iii) one or more power sources, said one or more power sources being adapted to rotate the one or more wheels;
(iv) a controller, said controller being adapted to control the movement of the inspection device.
(b) controlling the movement of the inspection device relative to the storage device.
